(19) United States
(12) Patent Application Publication
(10) Pub. No.: US 2006/0070507 A1
(43) Pub. Date: Apr. 6, 2006

(54) Structure for stringed instruments

(76) Inventors: Ilkka Nevanen, Helsinki (FI); Esa Hamalainen, Helsinki (FI); Timo Sairi, Helsinki (FI)

Correspondence Address: LADAS & PARRY, 26 WEST 61ST STREET, NEW YORK, NY, 10023, US

(21) Appl. No.: 10/528,048

(22) PCT Filed: Oct. 7, 2003
(86) PCT No.: PCT/FI03/00739

§ 371 Date: Mar. 16, 2005

(30) Foreign Application Priority Data
Oct. 8, 2002 (FI) 20021792

(51) Int. Cl. G10D 3/00

(52) U.S. Cl. 84/290

(57) ABSTRACT

The invention relates to a structure for stringed instruments comprising a body (1) made of mould material, a neck (2) fastened to the body and a head (3) fastened to the neck, wherein the head (3) is also made of mould material, the mould material of the body (1) and head (3) is composite mass, the neck (2) is made of a carbon fibre material, and the joints (4, 5) of the neck (2) to the body (1) and head (3) are implemented by moulding the mouldable composite mass of the body and head into an integral unit with the neck.

### BACKGROUND OF THE INVENTION

The invention relates to a structure for stringed instruments comprising a body made of mould material, a neck fastened to the body and a head fastened to the neck.

The material selection for the above-mentioned three components and their joining together have been the object of constant interest in guitar construction, in particular. In the search for new solutions, attention has been paid to the durability, costs, playability, weight and various acoustic properties of the instruments, for instance.

British application 2 037 049 discloses a cast unit which is formed from a head, neck and string anchor and can be attached to a variety of bodies. The object of this solution is to influence the factors listed above. However, the solution still involves the problem of how to arrange and attach the body to the above-mentioned unit.

U.S. Pat. No. 4,290,336 describes a head and a body made from mouldable materials which are connected to each other by conventional bolt fastening. Depending on the desired acoustic properties, for example, the body can be provided with a solid structure, foam structures or cavities. The primary motive for selecting this production method is to reduce the production costs of the instrument compared to traditional wooden instruments, in particular.

U.S. Pat. No. 5,682,003 discloses a semi-acoustic electric guitar where the design is based on the goal of reducing the size of this type of guitar. In this solution, the head, neck and center body member form an integral unit. The center body member is then provided with a separate left body member and a separate right body member. The unit is complicated and no detailed description is given on materials or the way of connecting the body members.

U.S. Pat. No. 5,895,872 describes a composite structure for a stringed instrument. One embodiment relates to an acoustic guitar where the neck, lower body part and body edges have been moulded in one piece from fibre reinforced material. The cover piece of the body has to be mounted and fastened separately. The electric guitar structure described in this patent greatly resembles the structure presented in U.S. Pat. No. 5,682,003.

U.S. Pat. No. 5,911,168 presents a guitar structure where the body and neck made of plastic material are formed in one piece using fibre structures at their connecting areas. These fibre structures are band-shaped pieces, which project over a considerable distance both into the body and the neck. The goal of this production method is to obtain as rigid a structure as possible at low costs.

In addition, a toy guitar is known from U.S. Pat. No. 4,088,050 where the lower part of the head, neck and body is moulded from plastic in one piece and covered with a separate upper part formed in the same manner. The teachings of this publication cannot, however, be applied to more demanding structures.

The problems associated with the prior art solutions described above include the high production costs due to several complicated production stages, which result in high purchase prices for consumers. In prior art synthetic solutions, problems also arise from heavy weight and tonal quality that is poorer than in traditional instruments.

### BRIEF DESCRIPTION OF THE INVENTION

The object of the invention is to eliminate the above-mentioned problems by providing a completely new structural solution for an instrument. This object is achieved by a structure for stringed instruments according to the invention, which is characterized in that the head is also made of mould material, the mould material of the body and head is composite mass, the head is made from carbon fibre material, and the joints of the neck to the body and head are implemented by moulding the mouldable composite mass of the body and head into an integral unit with the neck.

The invention is based on the idea that the body, neck and head of the instrument are formed into an integral unit in as few stages as possible using a suitable combination of materials without separate fastening means or materials. In the present invention, all this is achieved by means of a prefabricated carbon fibre neck and composite mould mass.

The composite mould body and head moulded directly into the carbon fibre neck provide better vibration properties in respect of tonal attack, tone, resolution and sustain than existing solutions provided with bolt and adhesive fastenings and neck joints that penetrate the body. The mould joint according to the invention is durable, flexible and inexpensive. The joints and materials used enable rising and lowering the pitch in a controlled manner by pushing or pulling the neck (cf. bridge). After the pushing or pulling, the instrument will be in tune again. Neither do variations in the air temperature and humidity cause changes that would affect the tuning state of the instrument. The joint between the body and neck can be formed such that the playability of the upper neck is considerably better than in conventional solutions since the neck needs not be reinforced at the joint, which is the case when, for instance, bolt fastening or conventional neck base reinforcement is used.

There may preferably be permanent cores moulded at least inside the mould mass of the body as well as cores that are removed after moulding. The cores that are left in place enable decreasing the weight of the instrument and improving the mass centre without unwanted resonances. The cores to be removed after moulding are employed for forming a hollow structure, in which case the electronics can be installed without separate fastening plates or fittings.

### BRIEF DESCRIPTION OF THE FIGURES

The invention will now be described in greater details by means of a preferred exemplary solution with reference to the accompanying drawings, in which

FIG. 1 illustrates a longitudinal cross section of an electric guitar in a plane parallel to the body;

FIG. 2 illustrates a longitudinal cross section of the electric guitar according to FIG. 1 in a plane perpendicular to the body; and

FIG. 3 illustrates a section III-III from FIG. 1.

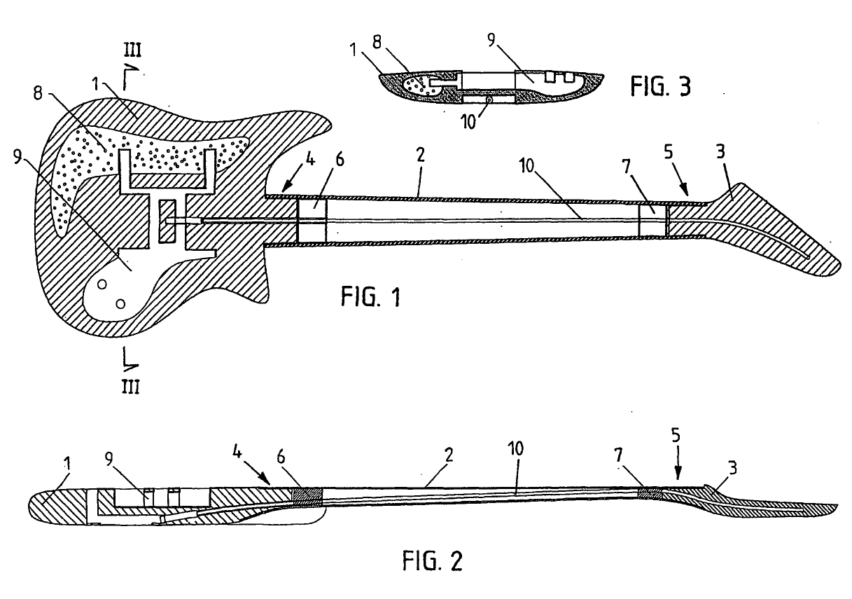

### DETAILED DESCRIPTION OF THE INVENTION

The figures illustrate a guitar structure according to the invention, which comprises three main components, i.e. a body 1, a neck 2 fastened to the body 1 and a head fastened to the neck 2.

The body 1 and head 3 are made of mould material consisting of composite mass. The same mass may be used as the material in both parts or, if necessary, masses with different compositions may be used in the body 1 and head 3. The basic component of the mould mass is a suitable plastic material. Instead, the head 2 is made of a carbon fibre material known per se that meets the set criteria.

The joints 4 and 5 of the neck 2 to the body 1 and head 3 are implemented by moulding the mouldable composite mass of the body 1 and head 3 into an integral unit with the neck 2. In this example, the neck 2 is completely hollow and the distance over which the mould material penetrates into the neck has been restricted by cores 6 and 7 installed inside the neck. In addition, a permanent core 8 and a core 9 to be removed after moulding have been moulded inside the mould mass of the body 1 for electronics to be mounted inside the body 1, for example. The core 9 may be removed by evaporating, dissolving or by means of a collapsible pneumatic core. In connection with the pneumatic ‘removal’, some core material will naturally be left in the instrument, but in practice it may be said that the core has been removed. Cores can also be placed elsewhere, for example in the neck area. A neck truss rod 10 is simultaneously embedded inside the instrument by moulding, in which case it is anchored to the head 3 by means of moulding.

The above description of the invention is only intended to illustrate the inventive concept. It is, however, clear to a person skilled in the art that this inventive concept can be implemented in various ways. Thus the invention is not limited to the example described above but its details may vary within the scope of the appended claims.

1. A structure for stringed instruments comprising a body made of mould material, a neck fastened to the body and a head fastened to the neck, wherein
the head is also made of mould material;
the mould material of the body and head is composite mass;
the neck is made of carbon fibre material; and
the joints of the neck to the body and head are implemented by moulding the mouldable composite mass of the body and head into an integral unit with the neck.

2. A structure for stringed instruments according to claim 1, wherein the neck is hollow and that the distance over which the mould material can penetrate into the neck is restricted by cores installed inside the neck.

3. A structure for stringed instruments according to claim 1, wherein at least one permanent core M is moulded at least inside the mould mass of the body.

4. A structure for stringed instruments according to claim 1, wherein at least one core to be removed after moulding is moulded at least inside the mould mass of the body.

5. A structure for stringed instruments according to claim 1, wherein a neck truss rod is embedded inside the instrument by moulding, in which case it is anchored to the head by means of moulding.
